(19) United States
(12) Patent Application Publication
(10) Pub. No.: US 2003/0209121 A1
(43) Pub. Date: Nov. 13, 2003

(54) Clamping and guiding device for working table

(75) Inventor: Sophia Wei, Taichung (TW)

Correspondence Address: BAKER & HOSTETLER LLP, Washington Square, Suite 1100, 1050 Connecticut Avenue, N.W., WASHINGTON, DC, 20036, US

(73) Assignee: Cie General International Mfre Ltee

(21) Appl. No.: 10/409,126

(22) Filed: Apr. 9, 2003

(30) Foreign Application Priority Data
May 11, 2002 (TW) 190369

(51) Int. Cl. B26D 7/06; B26D 7/27; B26D 7/28

(52) U.S. Cl. 83/438; 83/522.19

(57) ABSTRACT

A guide device for a working table, includes a seat, and a plate rotatably and adjustably secured to the seat for adjusting work pieces relative to the seat to different angular positions. A lock device is attached to the plate, for clamping the work piece to the plate, and a handle is selectively secured to either of the two sides of the seat, and to be located closer to users, for allowing the handle to be operated by either the right-handed or the left-handed users. A bracket may be selectively secured to either of the two sides of the plate, and located closer to users.

### FIELD OF THE INVENTION

The invention relates to a clamping and guiding device for disposing on a working table and for guiding the work pieces to be suitably machined by the saw or cutter blade of the working table.

### BACKGROUND OF THE INVENTION

Various kinds of typical clamping and guiding devices have been developed for being disposed on a working table and for guiding the work pieces to be machined by the saw blade or cutter blade of the working tables.

However, the typical clamping and guiding devices are normally designed for right-handed workers, and for allowing the work pieces to be guided and moved along or relative to the saw blade or cutter blade of the working table by right-handed workers only. The typical clamping and guiding devices may not be easily operated by the left-handed workers, such that the work pieces may not be suitably guided and moved or operated relative the saw blade or cutter blade of the working table by left-handed workers.

### SUMMARY OF THE INVENTION

It is an object of the present invention to provide a clamping and guiding device for allowing the work pieces to be suitably guided or moved by either the right-handed or the left-handed users or workers, and to be worked or machined by the saw blade or cutter blade of the working table.

According to the present invention there is provided a guide device for a working table, comprising a seat including two sides, a plate rotatably and adjustably secured to the seat for adjusting work pieces relative to the seat, a lock device attached to the plate, for clamping the work piece to the plate, and a handle selectively secured to either of the two sides of the seat, and to be located closer to users, for allowing the handle to be operated by either the right-handed or the left-handed users.

The plate includes two sides, and a bracket selectively secured to either of the two sides of the plate, and to be located closer to users, for allowing the bracket to be operated by either the right-handed or the left-handed users.

A beam may be selectively secured to either of the two sides of the plate, and to be located closer to users, the lock device is secured to the beam.

A base includes at least one rail disposed thereon, the seat is slidably engaged on the rail of the base, and a bar is adjustably secured to a bottom of the base for slidably engaging onto either of the guiding channels of the work table, and thus for guiding the base and the seat to move along or relative to the work table.

### BRIEF DESCRIPTION OF THE DRAWINGS

These and other objects and advantages of the invention will become apparent upon reading the detailed description and upon referring to the drawings.

FIG. 1 is a partial perspective view of a work table having a guiding device disposed thereon;

FIG. 2 is an enlarged partial perspective view of the guide device;

FIG. 3 is a perspective view of the guide device;

FIG. 4 is a partial exploded view of the guide device;

FIGS. 5, 6 are plan views illustrating the operation of the guide device for right-handed workers or users;

FIG. 7 is a partial perspective view similar to FIG. 1, illustrating the guiding device of the work table arranged for left-handed workers or users; and

FIG. 8 is a plan view illustrating the operation of the guide device for left-handed workers or users.

FIG. 9 is a partial perspective exploded view of a spring device mounted within the guide device.

FIG. 10 is a schematic side view of the spring device shown in FIG. 9.

FIG. 11 is a partial top view of the guide device along with two spring devices mounted therein.

FIG. 12 is a perspective exploded view of three spring devices mounted within a guide device.

While the invention will be described in conjunction with an example embodiment, it will be understood that it is not intended to limit the scope of the invention to such embodiment. On the contrary, it is intended to cover all alternatives, modifications and equivalents as may be included as defined by the appended claims.

### DESCRIPTION OF THE PREFERRED EMBODIMENTS

In the following description, similar features in the drawings have been given similar reference numerals and in order to weight down the figures, some elements are not referred to in some figures if they were already identified in a precedent figure.

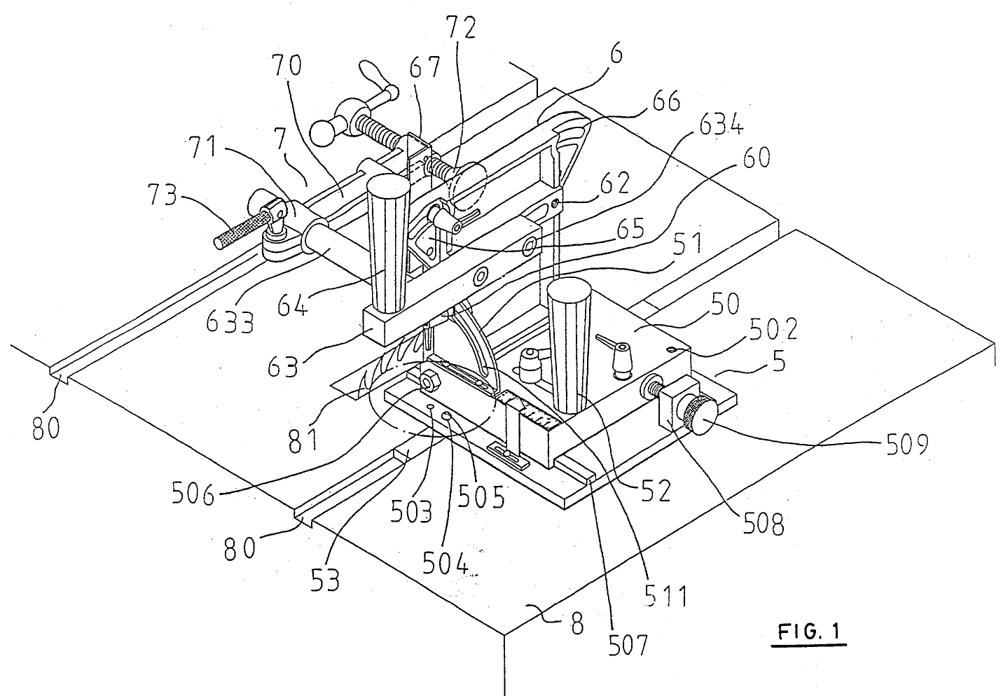

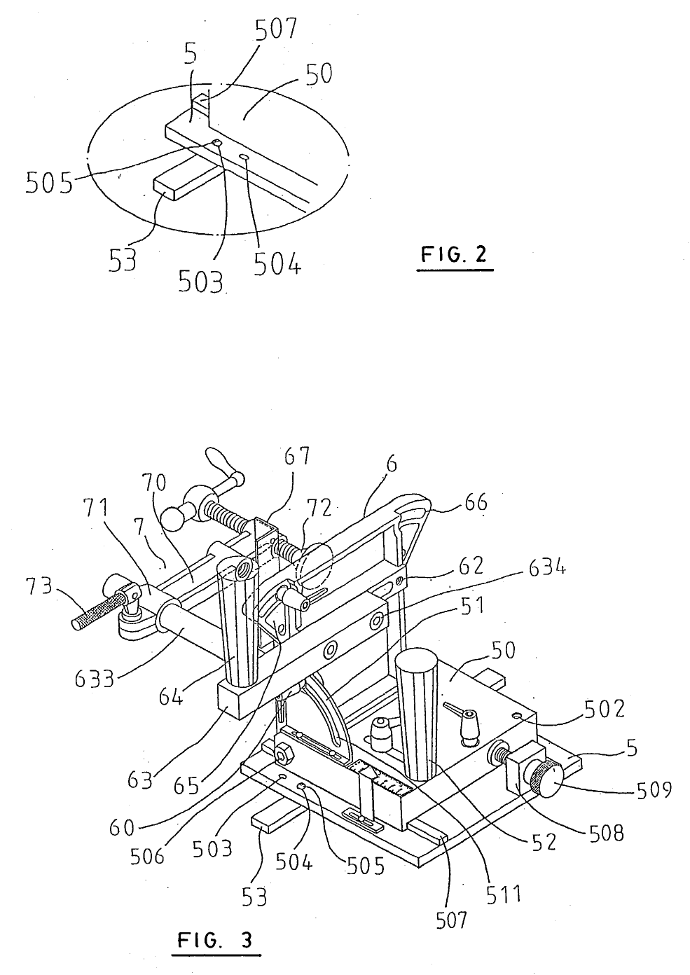

Referring to FIGS. 1-5, a guide device in accordance with the present invention is designed and arranged to be disposed on a work table 8 which includes one or more channels 80 formed on the upper portion thereof, and which includes one or more saw blade or cutter blade 81 slightly extended upwardly beyond the upper surface of the work table 8, and preferably parallel to the channels 80 thereof.

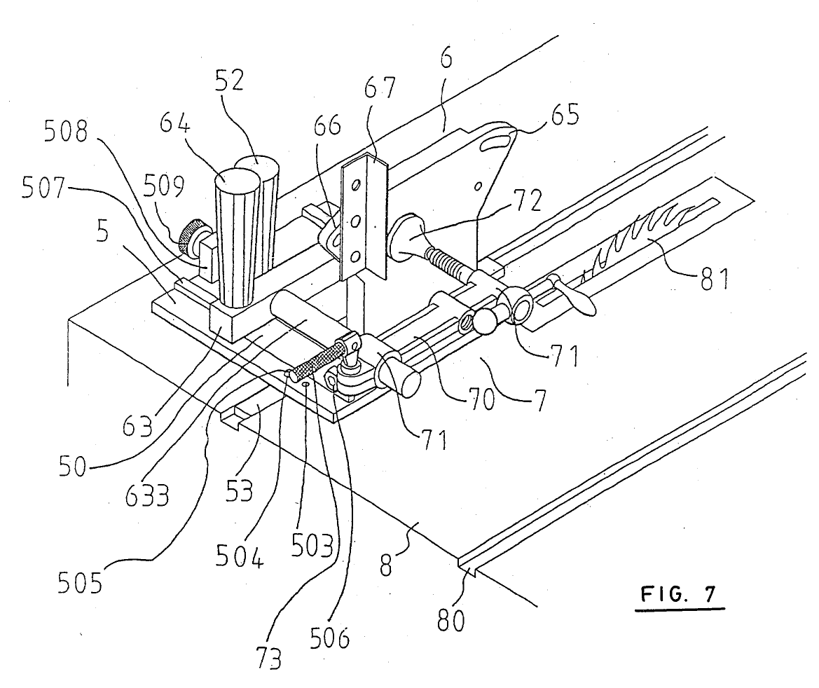

The guiding device comprises a base 5 including a bar 53 secured to the bottom and slidably engaged in either of the channels 80 of the work table 8, for guiding the base 5 and thus the guiding device along the channels 80 of the work table 8. The base 5 includes one or more holes 503, 504 for selectively receiving the fastener 505 which may secure the bar 53 to the base 5 at different locations (FIGS. 1, 7).

For example, as shown in FIGS. 3-6, when the base 5 is disposed on the right side of the saw blade 81, the fastener 505 may be engaged through the hole 504 and threaded to the bar 53. The arrangement is suitable for being worked or operated by the right-handed users. Similarly, the fastener 505 may also be engaged through the other hole 503 and threaded to the bar 53 for adjusting the base 5 relative to the saw blade 81 at different locations or positions.

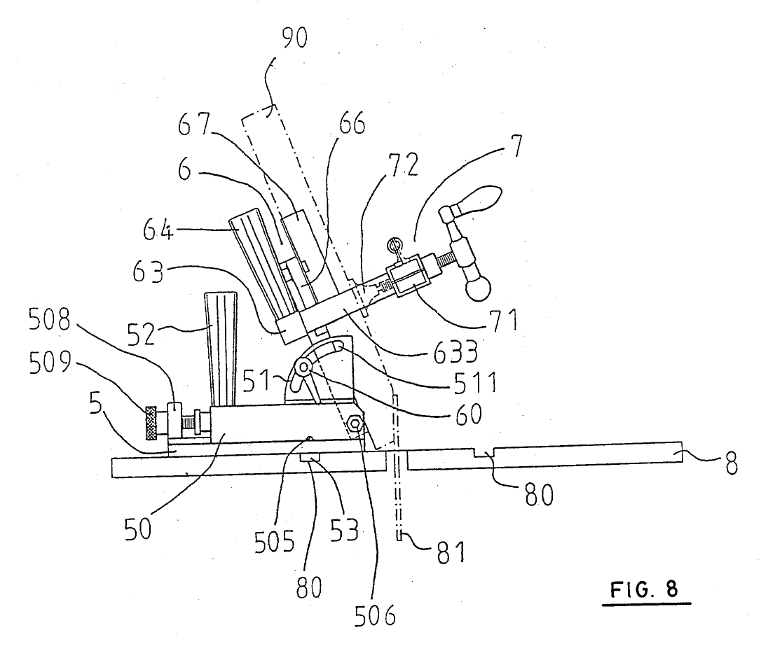

As shown in FIGS. 7-8, when the base 5 is disposed on the left side of the saw blade 81, the fastener 505 may be engaged through the other hole 503 and threaded to the bar 53. The arrangement is suitable for being worked or operated by the left-handed users. Similarly, the fastener 505 may also be engaged through the other hole 504 and threaded to the bar 53 for adjusting the base 5 relative to the saw blade 81 at different locations or positions.

A seat 50 is slidably engaged on one or more rails 507 of the base 5. The rails 507 are preferably perpendicular to the bar 53 and the saw blade 81, for allowing the seat 50 to be moved along the rails 507 and to be moved toward and away from the saw blade 81. A block 508 is extended upward from the base 5, and a bolt 509 is rotatably secured in the block 508 and threaded to the seat 50 for adjusting the seat 50 relative to the board 5 and the saw blade 81.

The seat 50 includes two screw holes 501, 502 spaced away from each other, for selectively threading or securing a handle 52. For example, as shown in FIGS. 3-6, when the base 5 is disposed on the right side of the saw blade 81, the handle 52 may be threaded to the screw hole 501 of the seat 50, such that the arrangement is suitable for being worked or operated by the right-handed users.

On the contrary, as shown in FIGS. 7-8, when the base 5 is disposed on the left side of the saw blade 81, the handle 52 may be threaded to the other screw hole 502 of the seat 50, such that the arrangement is suitable for being worked or operated by the left-handed users.

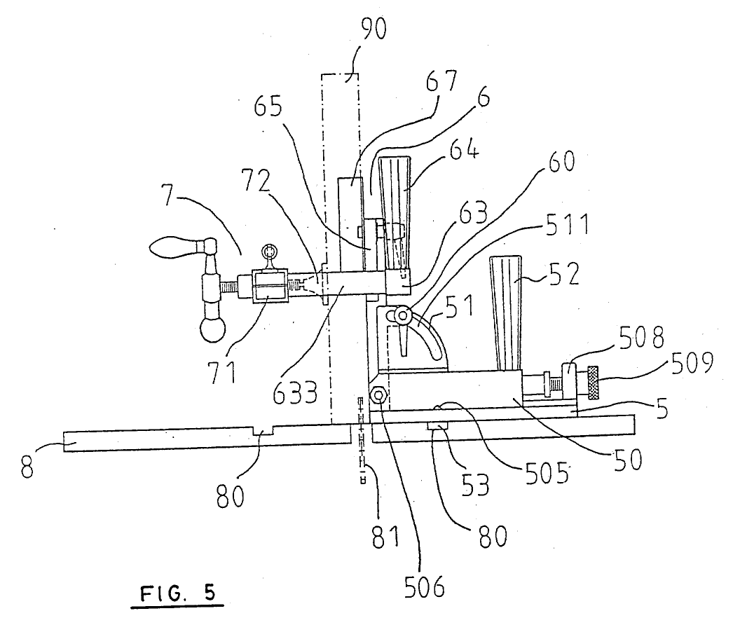

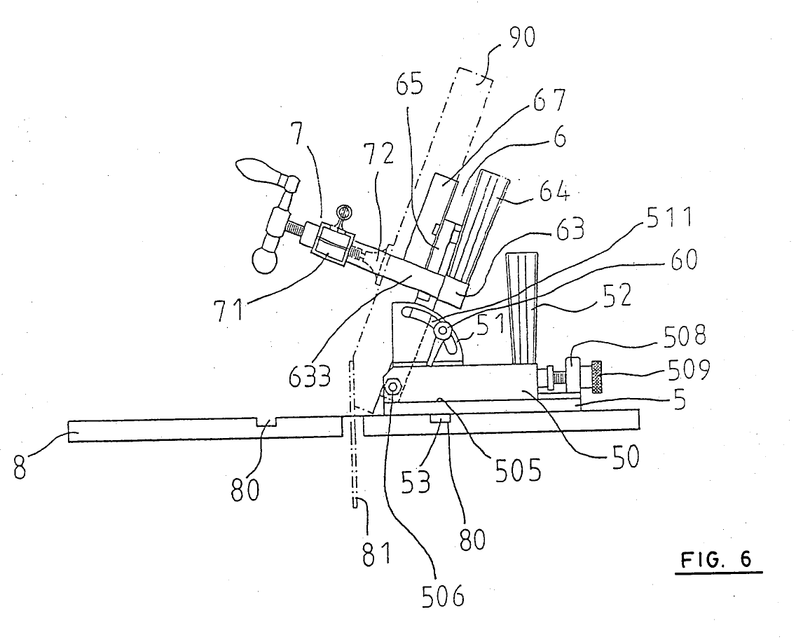

A plate 6 has a lower portion pivotally or rotatably secured to the seat 50 with a pivot shaft 506, for allowing the plate 6 to be rotated or adjusted relative to the seat 50 to different angular positions (FIGS. 5, 6, 8). The work piece 90 may be rested on the plate 6 (FIGS. 5-8), and thus may be rotated or adjusted relative to the seat 50 to different angular positions by the plate 6 (FIGS. 5, 6, 8).

The seat 50 includes a panel 51 disposed thereon or extended upwardly therefrom and having a curved slot 511 formed therein. The plate 6 includes a fastener 60 slidably engaged in the curved slot 511 of the panel 51, and selectively securable to the panel 51, for adjustably securing the plate 6 to the seat 50 at the required angular positions.

The plate 6 includes two side portions 65, 66 for selectively securing a bracket 67 thereon. For example, as shown in FIGS. 1, 3, 4, when the base 5 is disposed on the right side of the saw blade 81, the bracket 67 may be secured to one side 65 of the plate 6 and located closer to the workers or the users, such that the arrangement is suitable for being worked or operated by the right-handed users.

On the contrary, as shown in FIG. 7, when the base 5 is disposed on the left side of the saw blade 81+the bracket 67 may be secured to the other side 66 of the plate 6 and located closer to the workers or the users, such that the arrangement is suitable for being worked or operated by the left-handed users.

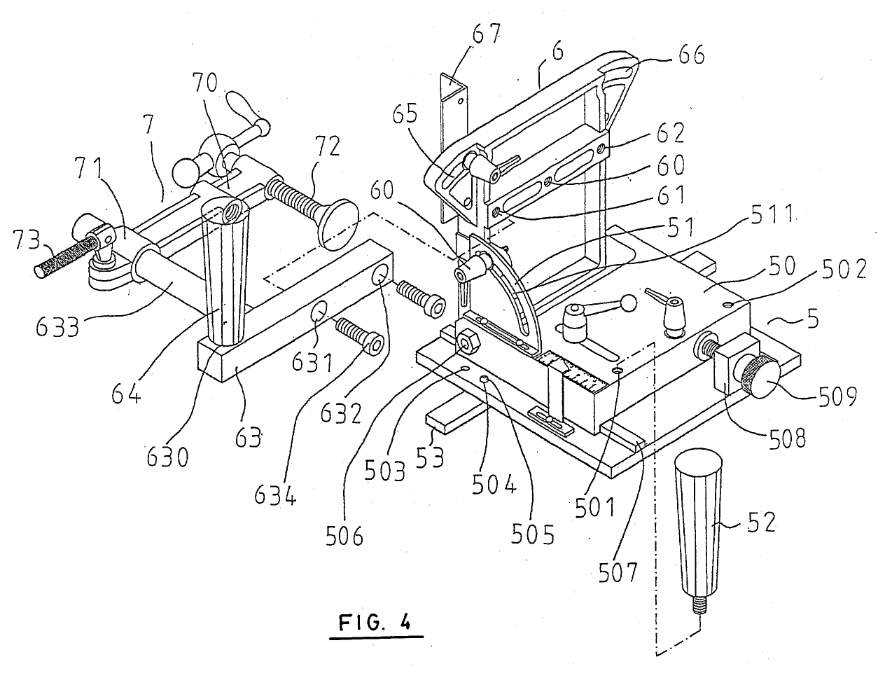

As shown in FIG. 4, the plate 6 includes two or more screw holes 60, 61, 62 formed in the middle portion thereof. A beam 63 includes two holes 631, 632 formed therein for receiving fasteners 634 which may engage with either of the screw holes 60, 61, 62 of the plate 6, for selectively or adjustably securing the beam 63 to the plate 6. A hand grip 64 may be secured to such as a screw hole 630 of the beam 63.

For example, as shown in FIGS. 3-6, when the base 5 is disposed on the right side of the saw blade 81, the fasteners 534 may be engaged through the holes 631, 632 of the beam 63 and threaded to the screw holes 60, 61 of the plate 6, for allowing the hand grip 64 to be secured or disposed closer to the users. The arrangement is suitable for being worked or operated by the right-handed users.

As shown in FIG. 7, when the base 5 is disposed on the left side of the saw blade 81, the fasteners 534 may be threaded to the other screw holes 60, 62 of the plate 6, for allowing the hand grip 64 to be secured or disposed closer to the users. The arrangement is suitable for being worked or operated by the left-handed users.

The beam 63 includes a rod 633 extended therefrom, preferably perpendicular to the beam 63 for slidably or adjustably securing a lock device 7. The lock device 7 includes an arm 70 having a barrel 71 slidably engaged on the rod 633, and selectively securing to the rod 633 with a fastener 73, and another fastener 72 rotatably or adjustably secured to the other end thereof for engaging with and for clamping the work piece 90 to the plate 6.

The work piece 90 may thus be stably and solidly secured to the plate 6 with the fastener 72 of the lock device 7, and may thus be stably guided or moved relative to the saw blade 81 with the seat 50, by moving the seat 50 and the base 5 along or relative to the work table 8.

In operation, the base 5 may be slidably disposed on either the right side (FIGS. 1, 5, 6) or the left side (FIGS. 7-8) of the saw blade 81. In addition, the handle 52 may be selectively or adjustably secured to either of the screw holes 501, 502 of the seat 50, and may thus be disposed closer to the users or workers, for allowing the guide device to be suitably worked or operated by either the right-handed or the left-handed users or workers.

Furthermore, the bracket 67 may be secured to either of the sides 65 of the plate 6, and may thus be adjusted and secured to the plate 6 at different locations or positions, and may thus be located closer to the workers or the users, such that the guide device is suitable for being worked or operated by either the right-handed or the left-handed users or workers. The hand grip 64 may also be selectively or adjustably secured to the plate 6 and located closer to the users or workers.

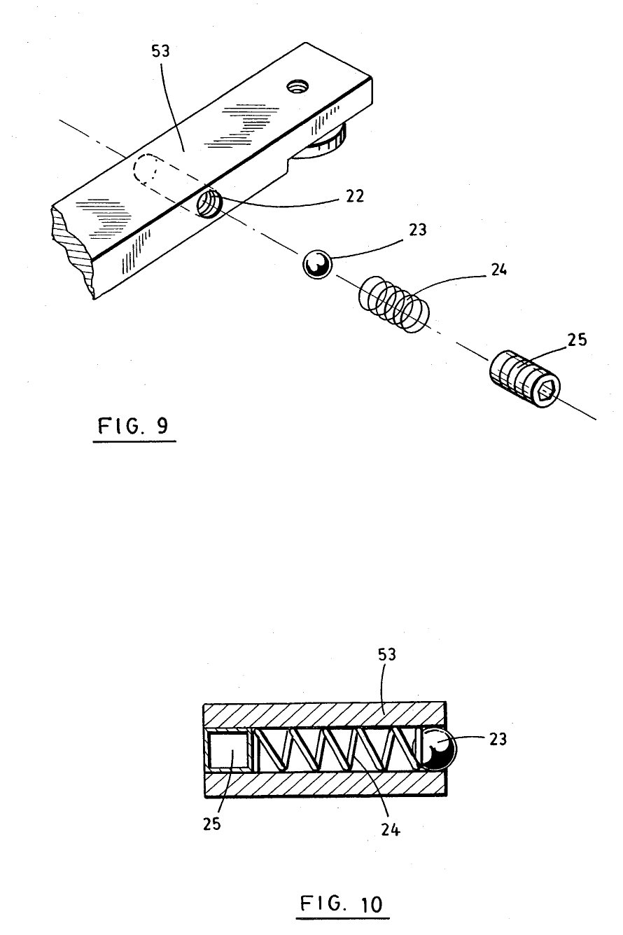

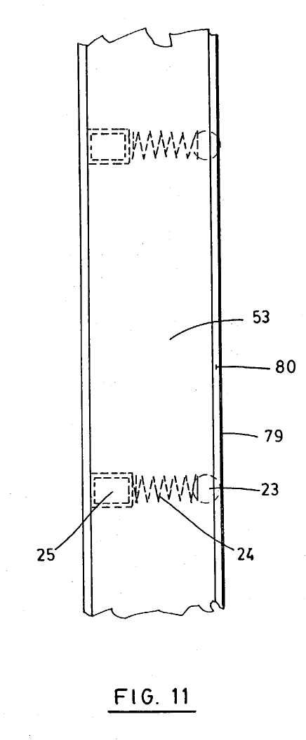

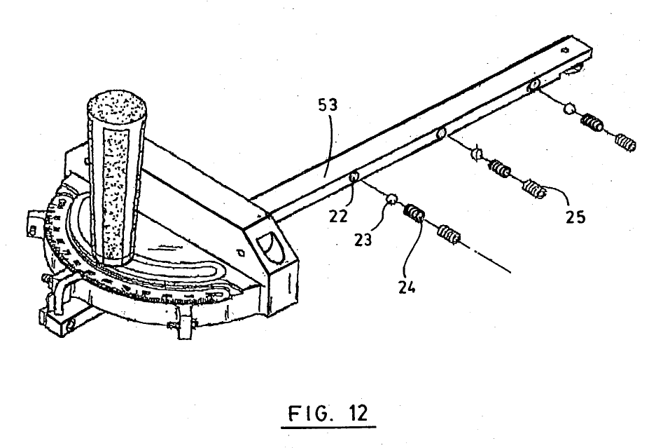

Referring to FIGS. 9-12, the bar 53 has preferably spring devices adjustable to the tolerance of width variation of the channel 80. For example, each spring device has a ball 23, a spring 24 and a stopper 25 all located within a partially obstructed through hole 22 in the bar 53. One end of the spring 24 presses against the stopper 25 while the other end presses against the ball 23.

The role of the spring device is to keep a constant pressure against the side walls 79 of the channel 80 so that the bar 53 is not too easily slideable within the channel 80 due to small variations in width all along the length of the channel 80. It will be appreciated that the diameter of this through hole 22 at the end where the ball is located should be slightly smaller than the diameter of the ball, otherwise the ball would fall out.

Accordingly, the guiding device may be used for suitably guiding and moving the work pieces relative to the saw blade or cutter blade of the working table, and to be suitably operated by either the right-handed or left-handed users or workers.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. A guide device for a working table, comprising:
a seat including two sides,
a plate rotatably and adjustably secured to the seat for adjusting work pieces relative to the seat,
a lock device attached to the plate, for clamping the work piece to the plate, and
a handle selectively secured to either of the two sides of the seat, and to be located closer to users, for allowing the handle to be operated by either the right-handed or the left-handed users.

2. The guiding device as claimed in claim 1, wherein the plate includes two sides, and a bracket selectively secured to either of the two sides of the plate, and to be located closer to users, for allowing the bracket to be operated by either the right-handed or the left-handed users.

3. The guiding device as claimed in claim 1, wherein the plate includes two sides, and a beam selectively secured to either of the two sides of the plate, and to be located closer to users, the lock device is secured to the beam.

4. The guiding device as claimed in claim 1 further comprising a base including at least one rail disposed thereon, the seat being slidably engaged on the rail of the base, and a bar adjustably secured to a bottom of the base.
